(19) United States
(12) Patent Application Publication
(10) Pub. No.: US 2003/0140751 A1
(43) Pub. Date: Jul. 31, 2003

(54) Saw guide pad seal

(75) Inventors: Ronald W. McGehee, Ukiah, CA (US); Patrick M. Doyle, Ukiah, CA (US)

Correspondence Address: HAYNES BEFFEL & WOLFELD LLP, P O BOX 366, HALF MOON BAY, CA, 94019, US

(73) Assignee: Coe Newnes/McGehee ULC, Salmon Arm (CA)

(21) Appl. No.: 10/321,470

(22) Filed: Dec. 18, 2002

Related U.S. Application Data
(60) Provisional application No. 60/344,261, filed on Dec. 28, 2001.

(51) Int. Cl. B26D 7/08; B26D 5/00

(52) U.S. Cl. 83/169; 83/821

(57) ABSTRACT

A saw guide pad seal enables recycling of the coolant/lubricant used in a lumber sawing operation. The saw guide pad seal directs the coolant to coolant return chambers. The coolant return chambers have a negative pressure developed from the motion of the saw blade or provided by a vacuum pump or blower, and return the coolant to the coolant tank. A heat-exchanger is optionally used to control the temperature of the coolant, providing more consistent operation of the saw, and a filter is optionally used to remove contaminants before the recycled coolant is provided to the saw blade(s).

### CROSS-REFERENCE TO RELATED APPLICATIONS

This application claims priority from U.S. Provisional Patent Application No. 60/344,261 entitled SAW GUIDE PAD SEAL, filed Dec. 28, 2001 by Ron McGehee and Patrick M. Doyle, the disclosure of which is hereby incorporated in its entirety for all purposes.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates generally to saws used for cutting timber into lumber, and more particularly to a saw guide pad seal that enables recovery and re-use of a coolant/lubricant liquid used during the sawing operation.

### BACKGROUND OF THE INVENTION

Thin-kerf, guided circular saws are used throughout the world for cutting lumber. Sawguiding systems require coolant and lubrication to take heat away from the saw blade and to reduce friction between the saw and saw guide bearing surface. Over the past 20 or 30 years there have been advancements in saw guide technology that include various types of cooling and lubricating systems. See U.S. Pat. Nos. 3,674,065; 4,635,513; 4,715,254; 4,848,200; 4,961,359; 5,159,866; and 6,050,163.

The current state of the art in saw guide and saw guide cooling and lubricating systems is to use babbitt or some other soft bearing material for the saw guide bearing surface. The saw guide and saw are lubricated with petroleum-based or plant-based lubricating oils, pumped through the face of the saw guide bearing surface. The saw guide and saw cooling is done with water pumped through the face of the saw guide bearing surface.

The current method of lubricating and cooling thin, guided circular saws has major economic and environmental problems. The majority of the lubricating oils currently used are petroleum based and are toxic to humans and the environment. Not only are these oils toxic, they are also expensive. The price, for these lubricating oils, currently ranges from $3.00 to $20.00 per gallon. The typical circular saw system will use between two (2) and 20 gallons of oil per day, depending upon the number of saw blades, size of saw blades and lubricating system adjustments.

This oil is not recycled. Once it is pumped through the face of the saw guide bearing surface it is carried out into the environment through various ways. Some of the oil is atomized by the high velocities in the area of the saw guide bearing surface/saw interface. Some of the oil is slung out in droplet form and is absorbed by the sawdust. Some of the oil is carried out on the lumber being sawn and probably worst of all, some of this oil is mixed with the saw cooling water and carried out through drains to holding ponds or sewer systems or even to storm run off channels. There is no way currently known that allows the recovery of this saw lubricating oil.

The saw cooling water suffers the same fate as the saw lubricating oil. However, there is a much higher volume of water to get rid of. Most of the water is absorbed by the sawdust. In many cases, the machine with the sawguiding system will sit at idle waiting for wood to be processed upstream or waiting on a break down downstream. When the machine is at idle, it still uses cooling water on the saws. With no sawdust to absorb this water, this water drains down into the waste conveyor system and eventually finding its way to, for example, the floor or the sewer drain.

### BRIEF SUMMARY OF THE INVENTION

A saw guide pad constructed according to one embodiment of the present invention includes a body having a bearing side configured to bear against the side of a saw blade. The bearing side has a discharge region coupled to a source of coolant and a coolant return chamber positioned towards the trailing portion of the bearing side. Coolant introduced at the coolant discharge region can cool the opposed saw blade and then be removed through the coolant chamber. A seal mounted to the bearing side of the body has a portion that extends outwardly of the bearing surface to facilitate removal of the coolant, which may then be returned to the coolant source. The coolant may thus be recirculated in a closed-loop system where it is optionally thermostatically controlled and filtered.

### BRIEF DESCRIPTION OF THE DRAWINGS

FIG. 1 is a simplified schematic of a system using saw guide pads according to an embodiment of the present invention.

FIG. 1A is a simplified side view of a saw guide according to an embodiment of the present invention.

FIG . 1B is a simplified plan view of a gang edger with saw guide assemblies and saw blades according to an embodiment of the present invention.

FIG. 2 is a simplified plan view of a saw guide pad according to an embodiment of the present invention.

FIG. 2A is a simplified cross-section of the saw guide pad shown in FIG. 2.

FIG. 2B is a simplified cross-section of the saw guide pad shown in FIG. 2A in contact with a saw blade.

FIG. 2C is a simplified cross section of an alternative saw guide pad shown in contact with a saw blade.

FIG. 3 is a simplified plan view of a saw guide pad showing mounting bolt holes.

FIG. 4 is a simplified plan view of a saw guide pad according to another embodiment of the present invention.

FIG. 5 is a simplified plan view of a saw guide pad with two vacuum chambers and a double-faced seal.

FIG. 5A is a simplified cross-section of a portion of the saw guide pad shown in FIG. 5.

FIG. 6 is a simplified plan view of a saw guide according to another embodiment of the present invention.

FIG. 6A is a simplified plan view of a saw guide pad with pressure equalization ports.

FIGS. 7A-7N and 7P-7X are simplified cross-sections of exemplary seals used with saw guide pads according to embodiments of the present invention.

FIGS. 8A and 8B show a saw guide pad in relation to a saw blade to illustrate fluid flow.

FIG. 8C shows a saw guide pad with multiple straight seals.

FIG. 8D shows a saw guide pad with a seal located in the interior of the perimeter bearing surface.

FIG. 8E shows a saw guide pad with a seal located in the inside of the perimeter bearing surface.

FIG. 8F shows a saw guide pad with a single straight seal.

FIG. 9 shows an end guide arm.

FIG. 9A is a simplified cross section of the end guide arm shown in FIG. 9.

FIG. 10 is a simplified side view of an interior guide arm.

FIG. 10A is a simplified cross section of the interior guide arm shown in FIG. 10.

### DETAILED DESCRIPTION OF THE INVENTION

I. An Exemplary Saw System and Exemplary Saw Guide Pads

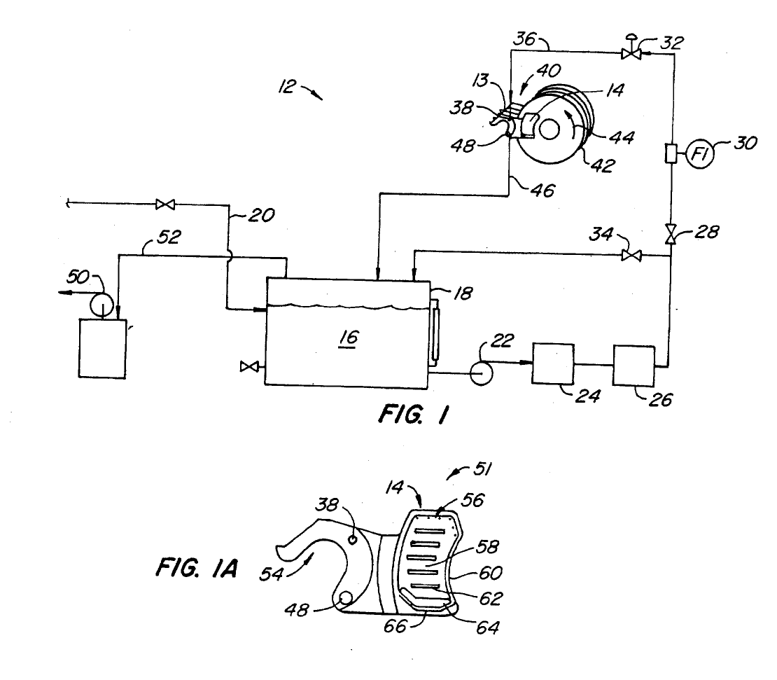

FIG. 1 is a simplified schematic of a system 12 using a gang of saw guides 13 with saw guide pads 14 according to an embodiment of the present invention. The new system will use a liquid coolant 16 to quench and lubricate the saw/guide interface. The coolant 16 is pumped into the saw guides 13, contacts the saw blade's surface, and recirculates back through a closed loop system where it is thermostatically controlled and filtered. Coolant 16 is initially provided to a coolant tank 18 through a coolant addition line 20. A coolant supply pump 22 pumps the coolant 16 through a heat exchanger 24 and a filter unit 26 to control the temperature of the coolant and to remove contaminates from the coolant. Flow of coolant 16 is adjusted with a flow control valve 28 and is indicated by a flow indicator 30. The flow may be shut off with a flow shut-off valve 32, and a flow return valve 34 allows the coolant 16 to be directly returned to the coolant tank 18. A coolant supply line 36 provides the coolant 16 to coolant supply headers 38 on the saw guides 40 that are typically guiding multiple circular saw blades 42 rotating in the direction shown by the arrow 44.

A coolant return line 46 coupled to vacuum headers 48 returns the coolant 16 to the coolant tank 18 after it has been used to cool and lubricate the saw blades 42 during the sawing operation. A vacuum pump or blower 50 provides a vacuum on the vacuum line 52, which maintains a negative pressure in the coolant tank 18. This negative pressure draws the recycled coolant 16 out of the vacuum chamber (not shown in this view, see Fig. 1A, ref. num. 64) in the saw guide (see Fig. 1A, ref. num. 51) and back to the coolant tank 18.

FIG. 1A is a simplified side view of a saw guide 51 according to an embodiment of the present invention. The saw guide 51 includes a saw guide arm portion 54 and a saw guide pad portion 14. The supply header 38 directs coolant to each saw guide pad 14 through the saw guide arm 54. The coolant is injected to the face of each saw guide pad 14 through several coolant discharge openings (coolant entrances) 56. The coolant flows through the contact cooling chamber 58 where contact with the saw blade's surface is made. A raised perimeter region 60 of a bearing surface of the saw guide pad 14 is preferably used to hold the coolant inside the contact cooling chamber 58. Bearing surface island regions 62 inside the contact coolant chamber 58 distribute the coolant and preferably act as hydrodynamic bearing surfaces.

A negative pressure is applied through the vacuum header 48 and internal passages (not shown) in the saw guide 51 to draw the coolant out of the contact cooling chamber 58 and into a vacuum chamber 64. Vacuum chamber 64 acts as a coolant return chamber 64 through which coolant is collected for return to the coolant tank (see FIG. 1, ref. num. 16). A seal 66 rides against the saw blade and is shaped to direct most of the coolant into the vacuum chamber 64.

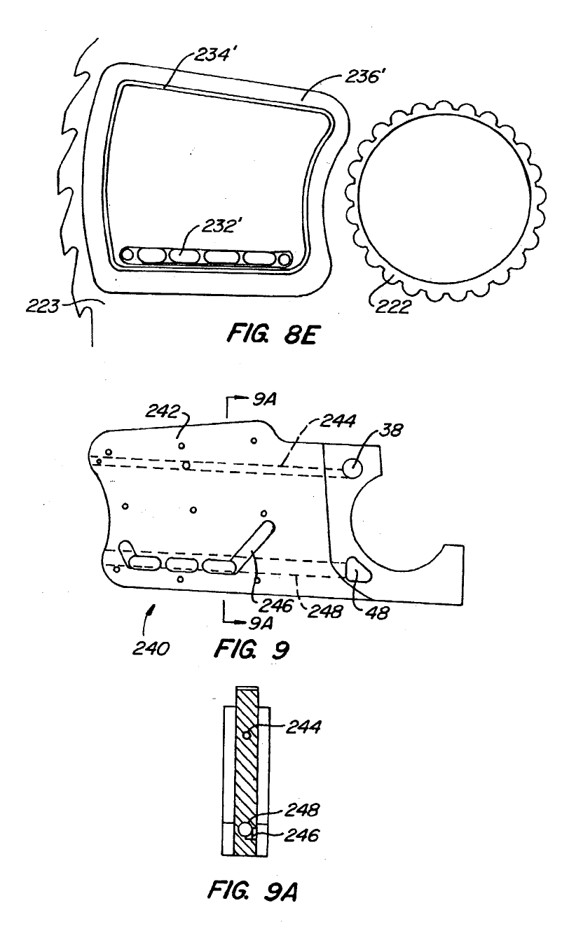

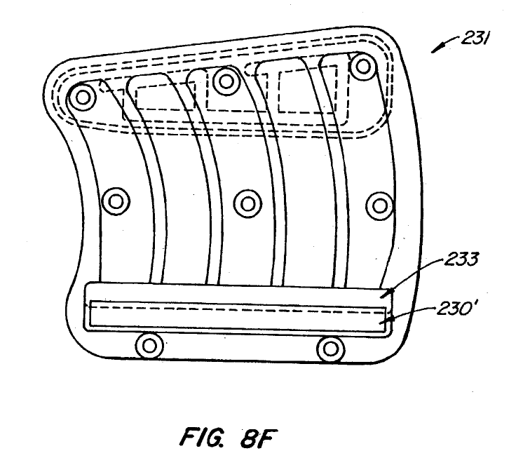

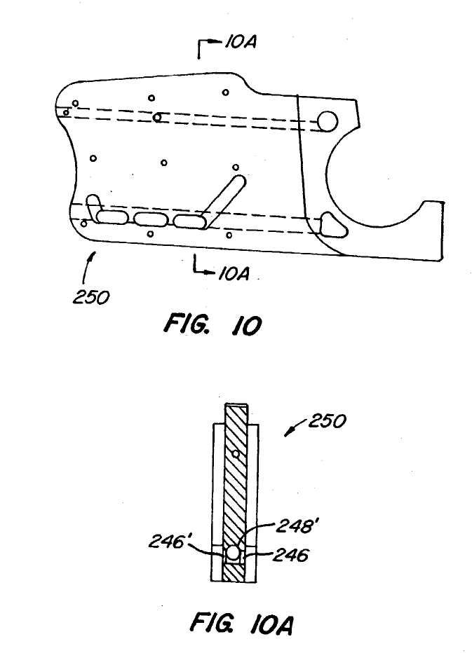

FIG. 1B is a simplified plan view of a gang edger 15 with saw guide assemblies 17, 17′, 19 and saw blades 42 according to an embodiment of the present invention. The saw blades 42 are mounted on an arbor 21 or drive shaft with intervening spacers 23 and rotate about an axis 25. The outer saw guide assemblies 17, 17′ include outer saw guide arms 240, 240′(see FIGS. 9, 9A), each with a single saw guide pad 14 and hence a single bearing surface facing the saw blade 42. An inner saw guide assembly 19, includes an inner saw guide arm 250 (see FIGS. 10, 10A), each with two saw guide pads 14. The inner saw guide assemblies 19 have two bearing surfaces, one on each side. Thus, each saw blade 42 is supported on each side with opposing saw guide pads 14. The saw guide pads could be the same on each saw guide arm, or different on some saw guide arms, and the saw guide pads could be integrated with the saw guide arms, or removably attached to the saw guide arms.

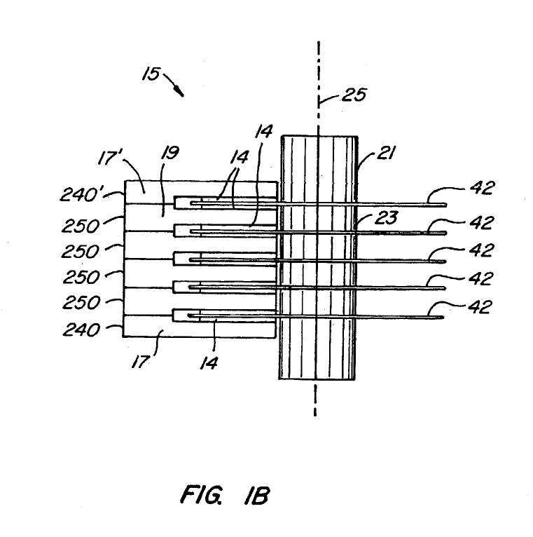

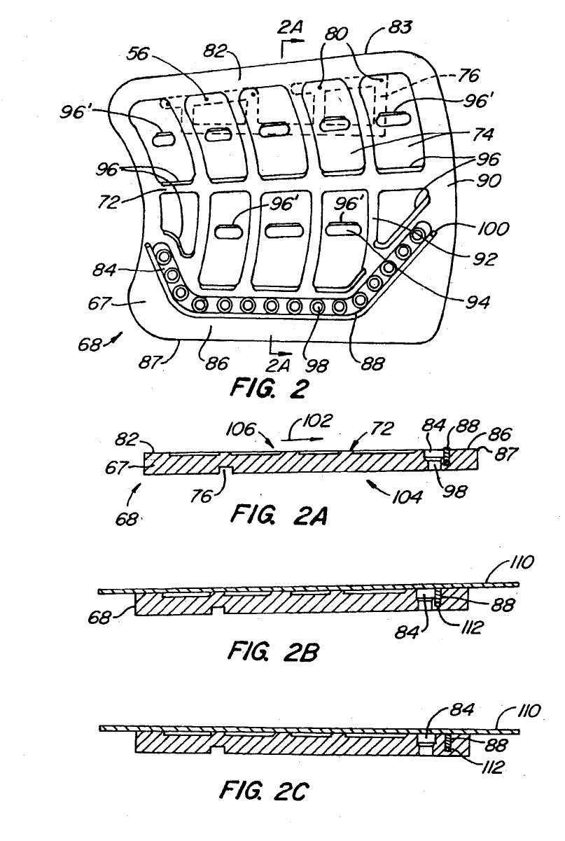

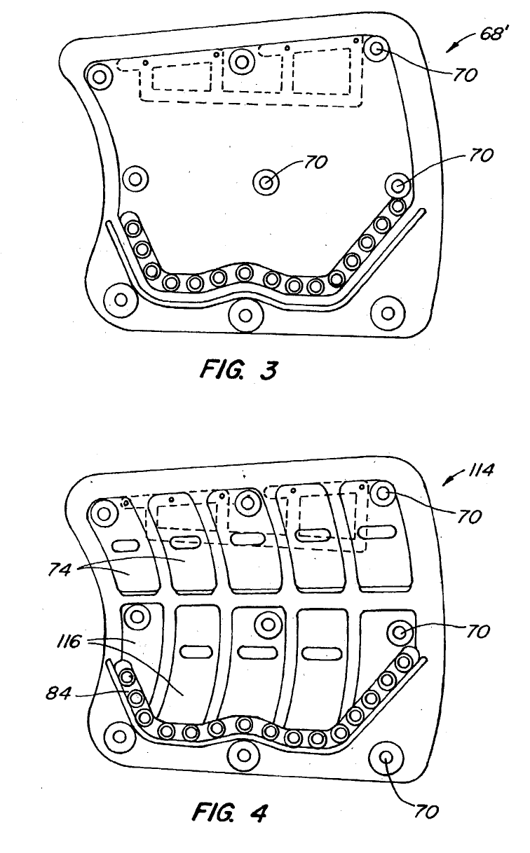

FIG. 2 is a simplified plan view of a saw guide pad 68 according to an embodiment of the present invention. The saw guide pad would typically be mounted to a saw guide arm using bolts, with the saw guide body 67 extending from an inner radial side to an outer radial side (relative to the center of the saw blade), and from a leading portion 82 to a trailing portion 86 (relative to the direction of the saw blade). FIG. 3 is a simplified plan view of a saw guide pad 68′ showing a typical arrangement of mounting bolt holes 70. The bearing surface side of the saw guide pad is shown. The opposite side of the saw guide pad is typically mounted to the saw guide arm, and is known as the guide arm side.

The bearing surface 72 shown in FIG. 2 has one or more coolant chambers 74 formed therein. A coolant is supplied from the coolant supply channel 76 (shown in dashed lines) through coolant discharge openings 56 to the bearing surface side of the guide pad 68 at coolant discharge regions 80. The coolant is preferably water plus a lubricant, such as a water-soluble synthetic soap solution, a semi synthetic or synthetic metal cutting lubricant, or a soluble vegetable oil. The coolant discharge openings 56 are located at the leading portion 82 of the bearing surface 72, which extends from the leading edge 83 of the saw guide pad body 67. A coolant return chamber 84 forms a coolant exit 84, which is typically a vacuum chamber, along the trailing portion 86 of the bearing surface 72. The coolant is removed from the coolant exit 84 through the vacuum chamber by the application of a negative pressure to the coolant exit 84 (by coupling holes 98 to the coolant tank 16) and the presence of a floating seal 88.

The coolant return chamber 84 is typically coupled to a vacuum source (coolant tank 16/vacuum pump 50) so that most of the coolant introduced into the coolant chambers 74 through the coolant discharge openings 56 flows from the leading portion 82 to the trailing portion 86 and exits the saw guide pad through the vacuum chamber 84. However, the coolant may be removed with or without the application of a vacuum source. The pumping action of the saw blade alone may be sufficient to remove the coolant.

The perimeter region 90 of the bearing surface 72 helps to hold the saw blade in position and also helps to contain the coolant. The clearance between the bearing surface, including the perimeter region 90, and the saw blade is typically between about 0.001 inch and 0.004 inch. The embodiment of FIG. 3 illustrates an embodiment in which the entire bearing surface consists of the perimeter region. In the embodiment of FIG. 2, the bearing surface includes supplemental bearing surface regions, such as bearing surface connector regions 92, which divide the coolant chamber 58 into an array of coolant chambers 74, and bearing surface island regions 94 located within the coolant chambers 74. The coolant within the coolant chambers is in direct contact with the saw blade and thus cools the saw blade through conduction. The elevations of the perimeter region 90, bearing surface connector regions 92 and bearing surface island regions 94 may be the same as or different than each other. The bearing surface connector regions 92 and the bearing surface island regions 94 may serve one or more of the following functions.

The bearing surface regions 92, 94 define each coolant chamber—providing areas for coolant to accumulate, typically upstream, (that is, in the direction of leading edge 83) of the bearing surface regions. The bearing surface regions 92, 94 can also enhance conductive heat transfer by mixing the coolant so that the hotter liquid on the saw's surface is continuously replaced by cooler liquid located away from the saw's surface. Ramped regions 96, 96′ leading from a coolant chamber to a bearing surface may help the bearing surface operate hydrodynamically, that is, to ride on a thin film of pressurized water. This hydrodynamic state causes the bearing surface to not contact the saw blade—greatly reducing friction and wear. Ramped regions 96, 96′ can lead from a coolant chamber to a perimeter bearing surface, or to a supplemental bearing surface, such as a bearing surface connector region 92 or a bearing surface island region 94. The bearing surface regions promote a more uniform flow distribution within a coolant chamber—preventing locally hot areas. Through holes 98 opening in the vacuum chamber 84 allow return of the coolant directed to the vacuum chamber, in part by the seal 88 that is fitted into a slot 100.

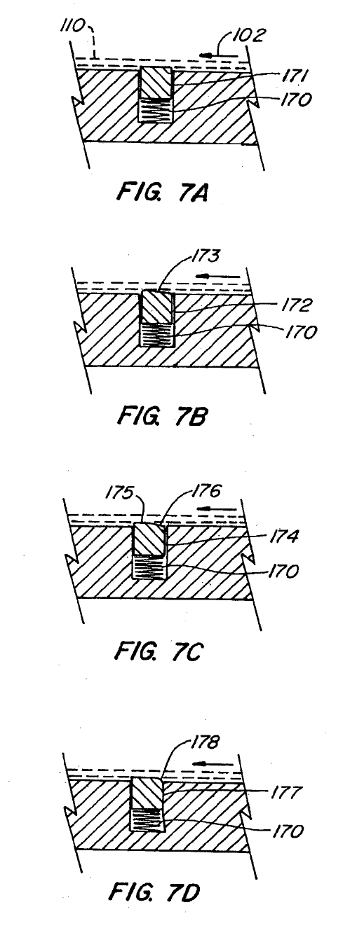

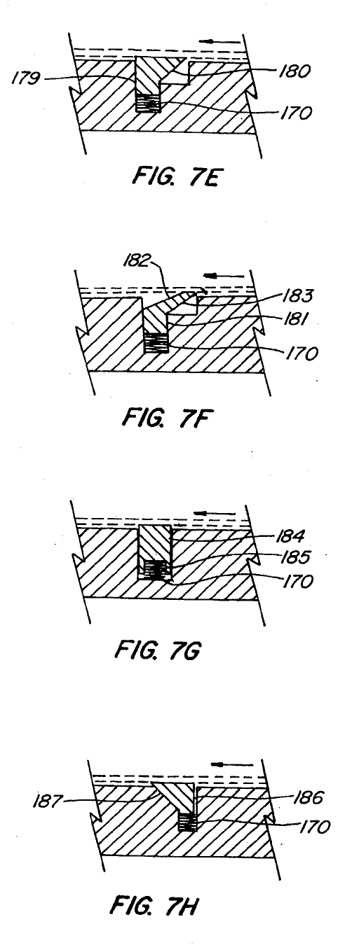

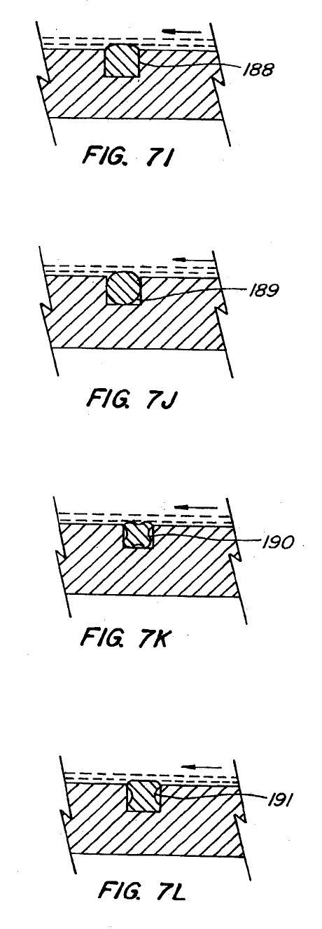

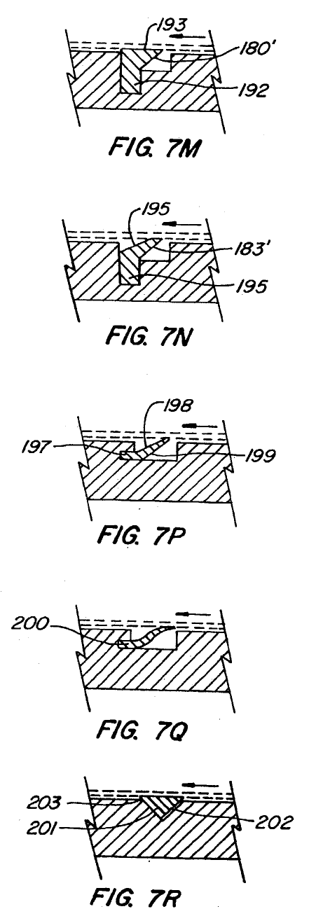

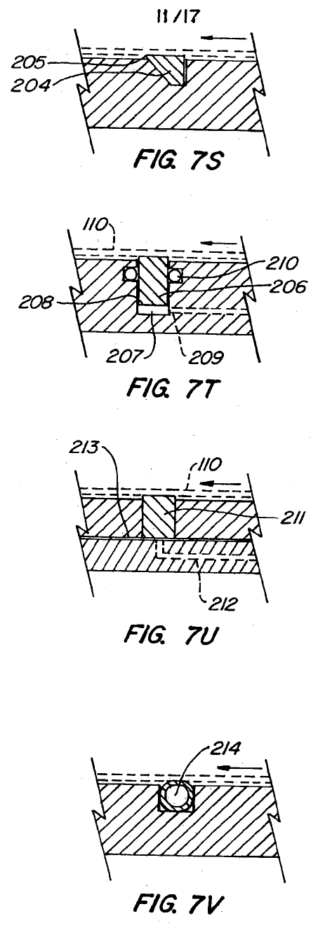

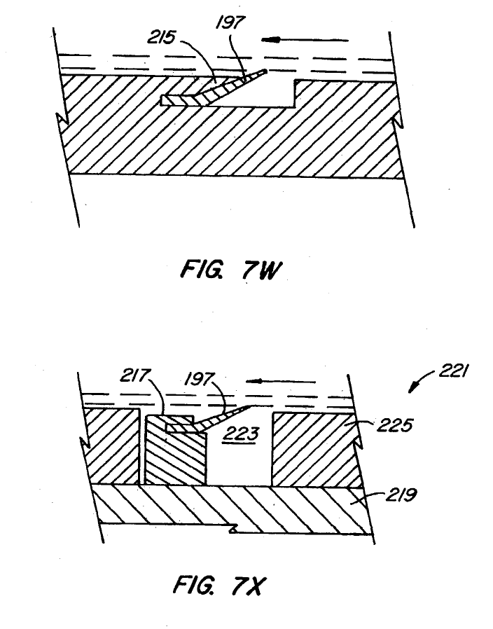

FIG. 2A is a simplified cross-section of the saw guide pad 68 shown in FIG. 2. The direction of movement of the saw blade relative to the saw guide pad body 67 is indicated by an arrow 102. The leading portion 82 and trailing portion 86 of bearing surface 72 are relative to the direction of movement of the saw blade. The saw guide pad 68 includes a guide arm side 104 and a bearing side 106, the bearing side having a bearing surface 72 that preferably acts as a hydrodynamic bearing surface. The coolant supply channel 76 is shown on the guide arm side. The seal 88 rides against the saw blade (see FIG. 2B, ref. num 110) and is typically housed within a slot located between the vacuum chamber 84 and the trailing edge 87 of the saw guide pad 68. FIGS. 2-2B illustrate the seal 88 positioned in contact with the vacuum chamber 84. FIG. 2C shows the seal 88 spaced apart from the vacuum chamber 84′, it could also be, for example, aligned with or at the trailing edge 87 of the saw guide pad 68. The seal 88 is preferably a floating seal biased against the saw blade 110 in one or more different ways. Typically, as shown in FIGS. 2B and 2C, the seal 88 is biased by an O-ring 112 positioned at the base of the slot. The seal may also be biased, for example, using coil springs, leaf springs, fluid pressure from below or the pressure from the coolant. Alternatively, the seal itself may provide its own spring force caused by its deflection from the saw blade. See FIGS. 7A-7X for various seal cross-sectional geometries and ways for biasing the seal against the saw blade.

FIGS. 4-6 show variations of interior raised features. FIG. 4 is a simplified plan view of a saw guide pad 114 according to yet another embodiment of the present invention, including mounting bolt holes 70 and coolant chambers 74, including coolant chambers 116 in fluid communication with the vacuum chamber 84.

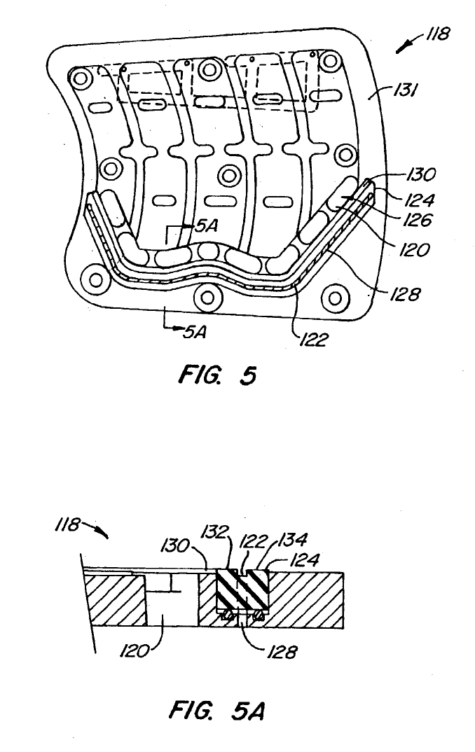

FIG. 5 is a simplified plan view of a saw guide pad 118 with two vacuum chambers 120, 122 and a double-faced seal 124. The first vacuum chamber 120 includes through slots 126 and is located before the double-faced seal 124. The second vacuum chamber 122 is formed within the double-faced seal 124 and enables water removal after the first face and before the second face. The double-faced seal is typically a single piece, but could be made-up of two or more pieces. As indicated by the dashed lines in FIG. 5A, through-slots 128 pass through both pad 118 and double-faced seal 124 to intersect second vacuum chamber 122. A slight recess 130, typically extending about 0.003 inch below the bearing surface region 131, is formed between the recess housing double-faced seal 124 and first vacuum chamber 120.

FIG. 5A is a simplified cross-section of a portion of the saw guide pad 118 shown in FIG. 5 showing the second vacuum chamber 122 between the first seal face 132 and the second seal face 134 of the double-faced seal 124. The slight recess 130 may help to direct coolant contacting the first seal face into the first vacuum chamber 120. The through slots 128 extending through the double-faced seal 124 to intersect the second vacuum chamber 122 are also shown.

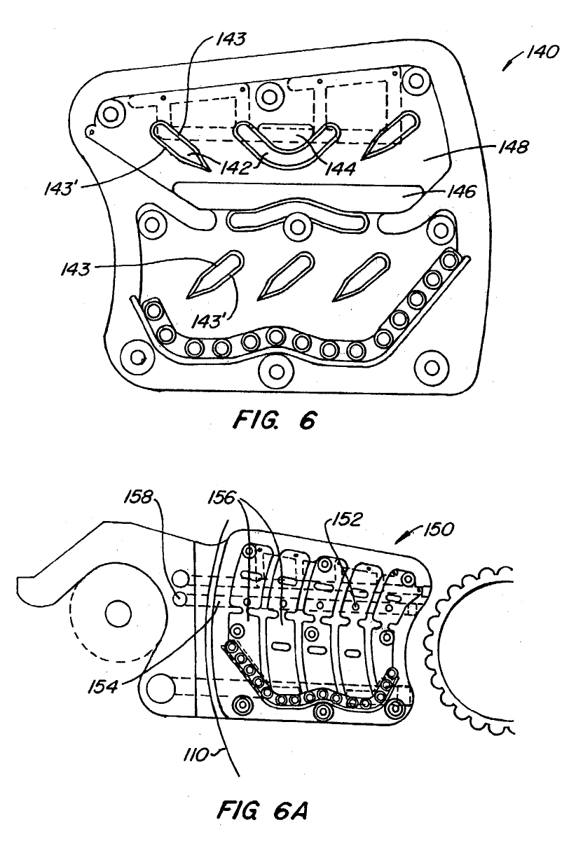

FIG. 6 is a simplified plan view of a saw guide pad 140 according to another embodiment of the present invention. FIG. 6 shows an example of how bearing surface island regions 142 might be configured to achieve uniform cooling. The bearing surface island regions 142 include leading ramped regions 143 and trailing ramped regions 143′. This pad also contains pockets 144, 146 that are recessed below the depth of the general coolant chamber 148—thus allowing additional water accumulation in these areas.

The invention may be practiced with bearing surfaces physically contacting the saw blade, and thus not in a true hydrodynamic state. However, by recycling the coolant, sufficient coolant may be pumped to achieve the desired hydrodynamic state without excessive costs and environmental degradation. Therefore, in the preferred embodiments the bearing surfaces typically act as hydrodynamic bearing surfaces. This is especially true of the bearing surface connector and island regions that are surrounded by coolant. The bearing surface perimeter region also preferably acts as a hydrodynamic bearing surface. However, it is expected that there is a greater likelihood of direct contact between the bearing surface perimeter region and the saw blade because (1) saw blade deflection forces are more pronounced along the periphery of the guide pad, and (2) air drawn into the space between the guide pad and the saw blade by vacuum forces may be primarily along the periphery. It is preferred that the system be run so that a thin film of coolant remains on the saw blade to provide at least a minimal lubrication film between the bearing surface and the saw blade. It may be desirable to equalize the pressure within the cooling chambers of the several saw guides to prevent excessive saw blade vibration.

FIG. 6A is a simplified plan view of a saw guide 150 with pressure equalization ports 152. The pressure equalization ports 152 in the saw guide pad and pressure equalization manifold 154, which is typically formed in the saw guide arm, connect the separate cooling chambers 156 to each other. The pressure equalization manifolds of the saw guides are coupled to each other through a pressure equalization header 158. Without these interconnected ports, the saw blade 110 may vibrate excessively at critical rotational speeds corresponding to harmonics of the system's natural frequency. These excessive vibrations may decrease the seal's efficiency and increase the wear on both the seal and the pad's bearing surfaces. If the saw guide arm is an interior saw guide arm, the pressure equalization header can equalize the pressure on both sides of the saw guide, and in the case of a saw guide pad body with first and second bearing sides, of equalizing the pressure within coolant chambers on the first and second bearing sides.

II. Exemplary Saw Guide Pad Seals

FIGS. 7A-7N and 7P-7X are simplified cross-sections of exemplary seals used with saw guide pads according to embodiments of the present invention. For example, FIG. 7A of illustrates an embodiment using a compression spring 170 (or springs) to bias a flat-topped rectangular seal 171 towards the surface of the saw blade 110 that is moving relative to the seal in the direction indicated by the arrow 102. FIG. 7B shows a spring-loaded rectangular seal 172 with an angular top 173. FIG. 7C shows a spring-loaded rectangular seal 174 with a flat top 175 having a beveled leading edge 176. FIG. 7D shows a spring-loaded rectangular seal 177 with a flat top having a raduised leading edge 178. FIG. 7E is a spring-loaded irregular seal 179 with a flat top with a leading edge compression ramp 180. FIG. 7F shows a spring-loaded irregular seal 181 with a beveled top 182 and a leading edge compression ramp 183. FIG. 7G shows a rectangular seal 184 with a recessed spring groove 185. FIG. 7H shows a spring-loaded irregular seal 186 with a trailing edge ramp 187.

FIGS. 7I through 7L show examples where the spring material also acts as the sealing agent. FIG. 7I shows a packing seal 188. FIG. 7J shows an 0-ring seal 189. FIG. 7K shows a quad-ring seal 190. FIG. 7L shows an irregularly shaped seal 191. Examples of spring materials that may also act as seals include natural and synthetic rubber; elastomers such as silicone, VITON™, or Buna-N; thermoplastics such as polyurethane, ultra-high molecular weight (“UHMW”) polyethylene or polytetrafluoroethylene (“PTFE”); metals including spring steel, tool steel, mild steel, stainless-steel or coated steels; packing materials such as flexible graphite, PTFE filament, KELVAR™, or other compression packings. These materials may be used in combination with each other or alone. The combination spring material and sealing agent may have solid, hollow or irregular cross-sectional shapes. Hollow spring materials may be fluid filled and may be designed to be filled with a variable pressure fluid. In addition to acting as combination spring material and sealing agent, these materials may be used with a separate sealing material, which would typically have a harder, more wear-resistant surface.

FIGS. 7M-7S illustrates that the seal can be configured so that moving coolant acts against the leading edge of the seal so that the amount of biasing force increases as the surface speed of the saw blade increases. FIG. 7M shows an irregular seal 192 with a flat top 193 and leading edge compression ramp 180′ without spring loading. FIG. 7N shows an irregular seal 195 with a beveled top 196 and leading edge compression ramp 183′ without spring loading. FIG. 7P shows a side-mounted irregular seal 197 with a beveled top 198 and leading edge compression ramp 199. FIG. 7Q shows a side-mounted curved seal 200. FIG. 7R shows a triangular seal 201 with a leading edge compression ramp 202 and a trailing edge ramp 203. FIG. 7S shows an irregular seal 204 with a trailing edge ramp 205. The embodiments of FIGS. 7E, 7F, 7H combine spring biasing and moving fluid biasing forces.

FIG. 7T shows a piston seal 206 that is biased against the saw blade 110 with pressurized gas or liquid provided to a distal portion 207 of the slot 208 at an inlet 209. An O-ring seal 210 maintains pressure in the distal portion of the slot while allowing the piston seal to move relative to the slot. FIG. 7U shows a piston seal 211 biased against the saw blade 110 by pressurized gas or liquid provided by a gas or liquid inlet 212 to a flexible membrane 213. FIG. 7V shows a gas- or liquid-filled seal 214. FIG. 7W shows a side-mounted irregular seal 197 that is similar to the seal shown in FIG. 7P with the addition of a cover 215 to protect the seal from accidental damage during handling.

FIG. 7X shows a seal 197 that is held in a bracket 217 that is attached to or part of a guide arm 219 of a saw guide assembly 221. The seal 197 extends through an opening 223 in the saw guide pad 225, and functions essentially the same as a seal mounted in the saw guide pad. Mounting the seal 197 on the saw guide arm 219 allows replacement of the saw guide pad 225 without disturbing the seal.

The concept of that the seal be a biased, floating seal is important because it helps to ensure the seal remains engaged with the saw blade surface even when the saw blade moves from side-to-side between the saw guide pads because the seal can move relative to the pad, and allows the user to adjust the force applied by the seal against the saw blade. The bearing force of the seal can be adjusted by, for example, replacing one O-ring or spring with a larger or smaller (or stiffer or less stiff) O-ring or spring. In the case where the seal provides its own spring force, the seal material, thickness, and shape could be adjusted to vary the force of against the saw blade. Also, shims could be used in conjunction with the biasing element to change the height of the biasing element within the slot.

During startup and shutdown the seal typically contacts the surface of the saw blade. Once the saw blade is rotating at a high enough speed, a hydrodynamic state is reached when the seal spring force is less than the pressure within the film of coolant between the seal and the saw blade. In this state little to no surface-to-surface contact is present. This condition allows the seal to experience minimal wear over time. The seal material, its shape, the spring force, and the seal groove geometry are designed to work together to leave a thin film of coolant on the saw blade—providing beneficial evaporative cooling of water into the atmosphere, quickly achieve a highly efficient seal (above 99% of coolant going into the guide is typically returned back to the supply tank), mate effectively against different saw blade surfaces, produce minimal friction on the saw blade, wear the seal material slowly, and/or help the seal stay secured inside the guide pad when handled by machine tenders during saw change operations.

It has been found that conventional copper-based seal materials, such as brass alloy C260, C360, C356 or aluminum bronze alloy C954, work well but suffer from the relatively short life. It is believed that the short life is due to higher rates of wear during startup and shutdown, at which time the softer seal material is in direct contact with a much harder saw blade. While softer seal materials work, seals made of hard, tough materials, such as tungsten carbide, silicon carbide, or ceramics, which are generally harder than saw blades, may be preferable. The seal may be made of the same material throughout or it may be a surface treated material, such as tungsten-carbide-coated or ceramic-coated mild steel. Instead of harder, metallic materials, preliminary tests indicate that the seals made of a one or more polymers, such as PTFE, Delrin® acetal resin, KYNAR® Polyvinylidene Fluoride (PVDF) resin, and PEEK, work well.

III. Fluid Flow and Seal Layout

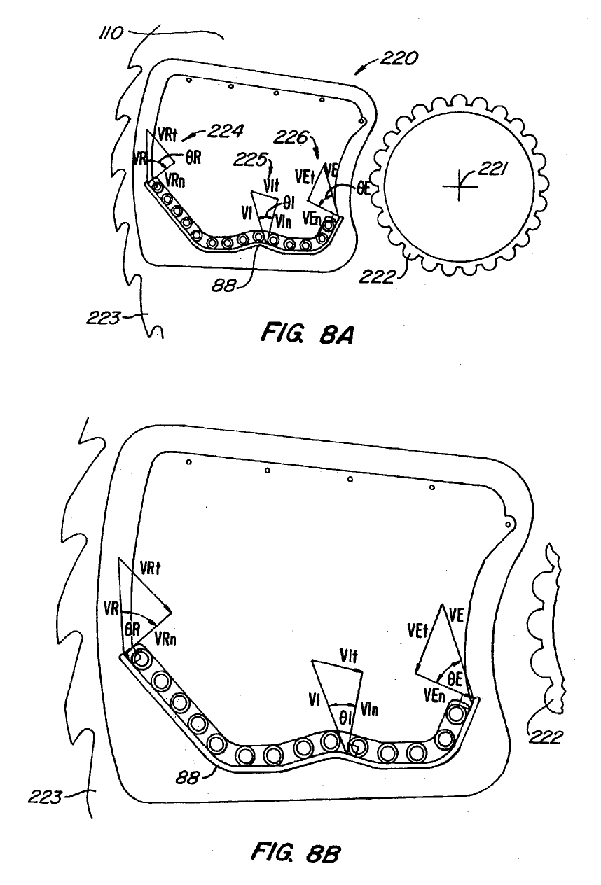

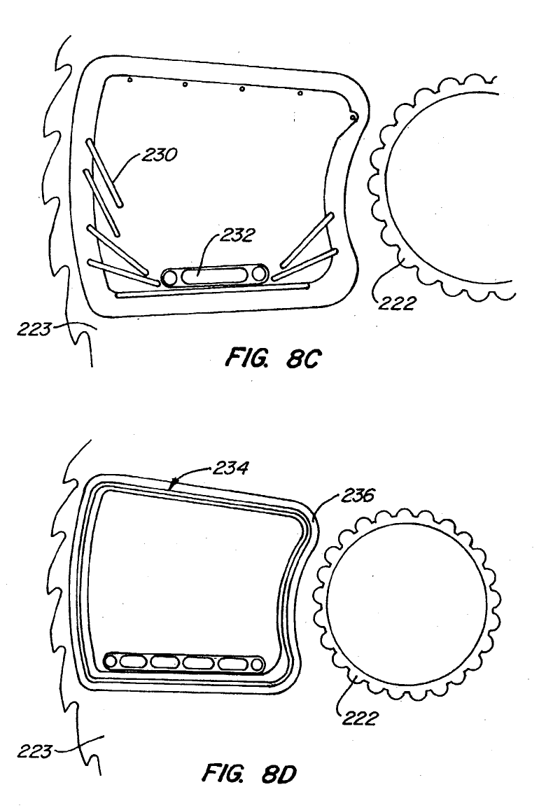

FIGS. 8A and 8B show a saw guide pad 220 in relation to a saw blade 110 to illustrate fluid flow at the saw guide pad/saw blade interface. Both the shape and position of the seal(s) can direct fluid flow. FIG. 8A shows the saw blade 110 having a blade center 221, an eye 222, and a rim 223. Three vector diagrams 224, 225, 226 are illustrated for coolant that is assumed to be traveling in the direction of the saw blade's surface. V_{R} represents the coolant velocity near the rim, V_{I} represents the coolant velocity at the interior, and V_{E} represents the coolant velocity near the eye. V_{Rt} is the tangential component of the vector V_{R}, and V_{Rn} is the normal component of the vector V_{R} (relative to the edge of the seal 88), and so forth for V_{I} and V_{E}. The angles formed between the velocity vectors and their normal components are represented by θ_{R}, θ_{I}, and θ_{E}, respectively. FIG. 8B shows the relationship of the various vectors on a larger scale.

The shape of a floating saw blade seal in the plane of the bearing surface of a saw guide preferably meets the following guidelines: the seal is non-continuous; at the ends of a non-continuous seal, the components of the overall coolant velocity vectors tangential to the seal's leading edge preferably point inwardly towards the interior of the seal; and on a non-continuous seal, the seal preferably extends further away from the trailing edge of the guide pad at the rim than at the eye of the saw blade. The shape of such a non-continuous seal embodiment is important in that the seal should direct flow inwardly from its ends to prevent coolant from spilling out of the guide pad. Seals similar to the embodiment illustrated in FIGS. 8A and 8B that have ends with a tangential velocity component of zero or positive in a direction pointing away from the interior of the seal tend to not contain the coolant effectively.

FIGS. 8C-8F show saw guide pads with shaped seals. The shaped seals help ensure that substantially all of the coolant gets recycled through the vacuum chamber. FIG. 8C shows a configuration with multiple straight seals 230 to direct the coolant to the vacuum chamber 232. FIG. 8D shows a continuous-loop seal 234 contained within the perimeter region 236 of the bearing surface. The embodiment of FIG. 8E is similar to the embodiment of FIG. 8D in that it has a continuous seal 234′, but the continuous seal lies interior of the perimeter region 236′ of the bearing surface, adjoining the vacuum chamber 232′. On a continuous seal, reducing the force of the seal against the saw blade along the leading edge of the guide pad may be desirable to allow coolant adhering to the saw blade to re-enter the cooling and vacuum chambers. FIG. 8F shows a saw guide pad 231 with a single straight seal 230′ inside a vacuum chamber 233. This single straight seal 230′ performs adequately well under certain operating conditions.

IV. Guide Saw Support Arms

Guide arms support the guide pads, determine saw-to-saw spacing, deliver coolant, and return coolant. On a multiple saw gang edger, the guide arms are supported by a common shaft. The guide arms are clamped together on the shaft and held in position by a mechanical stop.

FIG. 9 shows an end saw guide arm 240 that supports a single saw guide pad (not shown) on a saw guide pad mounting surface 242, while each interior saw guide arm (see FIG. 10) supports two saw guide pads, one on each side of the interior saw guide arm. There is an end saw guide arm on each end of the saw gang edger. A series of holes 244 drilled in the saw guide arm 240 direct coolant from the coolant supply header 38 to the face of the saw guide pad mounting surface 242. A vacuum chamber(s) 246 is machined in the face of the saw guide arm to mate with the vacuum area(s) in the saw guide pad. A hole or series of holes 248 then channels the return coolant into the vacuum header 48.

To promote uniform coolant removal, the vacuum chamber 246 at both ends increases in depth towards the center of the saw guide pad. Optional pressure equalization ports and pressure equalization manifolds connect the cooling chambers on the saw guide pads with each other through a pressure equalization header, as shown in FIG. 6A. Constructing a one-piece saw guide arm/pad assembly is possible, however using a bolt-on saw guide pad is often preferred because the saw guide arms are typically aluminum while the saw guide pads are made of various bearing materials, the saw guide pads typically wear out much faster than the saw guide arms, and machining costs are less since the milled pockets on both the front of the saw guide arm and the back of a bolt-on saw guide pad are easier to machine than a series of interconnected, drilled holes in an integrated saw guide assembly.

FIG. 9A is a simplified cross section of the end saw guide arm 240 shown in FIG. 9, illustrating coolant supply header hole 244, vacuum header hole 248, and vacuum chamber 246.

FIG. 10 is a shows an interior saw guide arm 250 similar to the end saw guide arm 240 shown in FIG. 9; however, an interior guide arm 250 typically has a saw guide pad on each side of the saw guide arm. FIG. 10A shows the vacuum header hole 248′ being coupled to vacuum chambers 246, 246′ on both sides of the interior saw guide arm.

V. Variable Saw Guide Pad Features

To provide cooling, coolant (typically primarily water) removal and bearing support in relation to the blade's surface speed, several saw guide pad features may vary from the eye to the rim of the blade. Coolant discharge opening diameters may vary in relation to the blade's surface speed at the local point of entry. These may be fixed ports or ports having variable restrictions such as a replaceable orifice or an adjustable needle valve. For example, the coolant entrance openings 56 in the embodiment of FIG. 2 may gradually increase in size from left to right in FIG. 2 according to the increase in radius of the opposed saw blade.

Vacuum chamber features may vary to accommodate higher water removal levels towards the rim of the blade. The depth of the seal groove may decrease towards the rim of the saw to cause a higher sealing pressure at the higher velocity areas. The bearing surface regions may increase in surface area in zones of higher blade velocity and/or higher bearing forces. The depths of the coolant chambers relative to the raised perimeter could be either constant across the guide pad, as shown in FIGS. 3 and 5, or may change depending on local blade surface speed. FIGS. 2 and 4 show a guide pad with ten coolant chambers with depths that vary with the square of the saw's radius. Alternatively, the depths of the coolant chambers of the embodiment of FIGS. 2 and 4 could vary, for example, from 0.010 inch to 0.030 inch in 0.005 inch increments.

VI. Specific Advantages over Conventional Saw Guide Pads

Many saw mills use or sell their waste wood and saw dust for power generation. A typical 40 saw gang edger machine would currently have approximately 10 gallons-per-minute of coolant (99% water, 1% mineral oil) going into their sawdust. This equals 120,000 lbs/day of extra water to evaporate before the dust will burn. This extra moisture reduces the fuel value of the sawdust and can equate to well over $1,000 per day of lost revenue at a typical sawmill. In addition, if the sawdust is transported before burning, the transportation costs are increased by the weight of the extra water.

The new saw guide system recycles the coolant, therefore losing very little into the sawdust. If the same 40 saw gang edger has a recycled coolant system made according to the invention that operates at 40 gallons per minute of coolant at a 99% sealing efficiency, the loss equals less than one half of a gallon per minute. (Testing indicates a sealing efficiency of at least 99% is achievable with the present invention.) This high efficiency reduces the evaporation expense by approximately 95% (from, for example, $1000 to $50 per day).

Efficiently sealing the saw guide/saw interface and recycling the lubricating and cooling fluids greatly reduces the amount of toxic materials released into the environment. This can have a big impact at very remote mill locations where contaminated saw cooling water gets into streams, lakes and rivers. In many cases, the contaminated dust is burned in a boiler to make steam for heating the drying kilns or to produce electricity. Reducing the oil contamination in the sawdust waste stream will reduce the amount of petroleum products being burned and reduce the emission of toxic smoke into the atmosphere. There are many other environmental, human safety and waste disposal problems associated with using large quantities of toxic petroleum based lubricants.

Recirculating coolant/lubricant allows the use of more expensive lubricants, a higher concentration of lubricants, and a greater quantity of coolant to be directed at the saw blade because the fluid is not lost in a waste stream. A higher concentration of lubricant and higher flow of coolant can greatly improve the wear rate and extend the life of the saw guide pads. By eliminating the use of petroleum-based saw lubricants and replacing them with bio-degradeable organic lubricants, millions of barrels of oil that would otherwise be used to lubricate saw blades can be saved. The world's supply of clean water is also under pressure from industrial and agricultural pollution. A saw system that recycles saw coolant can reduce the water consumption of the sawmills by as much as 90%. This is a huge volume of water world-wide. Using biodegradable lubricants and recycling the lubricant/coolant mixture will be more socially acceptable because it is good for the environment, thus making sawmills more acceptable.

Saws that run too hot or have too high of a temperature gradient distort and do not cut accurately. In the worst conditions, this can lead to catastrophic saw or guide failures. Saws heat up for several reasons: side loaded saws may get pushed into the guide, contaminates and saw dust may enter in between the guide and saw, or the wood being cut may rub against the saw. These all cause fiction and heat that raise the temperature of the saw blade. The rise is typically localized to one area of the blade—causing a temperature gradient that will often distort the saw blade. Traditional saw guides cool the blade by injecting a mist of water and lubricants into the guide pad with compressed air. The water, lubricant and air exit the pad through a small clearance gap (typically 0.001 inch to 0.004 inch) between the perimeter of the pad and the surface of the saw blade. While in the pad, the water and lubricant are in poor contact with the blade because the air traveling at a high velocity forces them out of the pad quickly and prohibits good surface contact.

A saw guide system constructed according to embodiments of the invention can improve heat transfer between the saw blade and a coolant. The coolant is preferably a thermostatically controlled recycled coolant. The improved heat transfer is achieved through increasing the amount of conductive heat transfer between the coolant and the saw blade by holding more coolant in direct contact with the blade. Coolant flow rates of 4 to 8 times higher than traditionally lubricated guide pads are now practical since the coolant is recycled. Also, the seal in the guide pad can be designed to leave an ultra-thin water layer on the surface of the blade to maximize the positive effects of evaporative cooling.

The ability to cool more quickly and more uniformly will produce lumber cut closer to target dimensions. An increase in sawing accuracy will lead to reductions in rough green lumber size, which will increase utilization of the raw material (that is, make more lumber out of the same amount of logs). This improvement in sawing accuracy is brought about by being able to run more coolant and lubricant (because they are recovered and reused), which will allow the saws to run at a more constant temperature and therefore reduce temperature-related sawing deviations. Reduction in overall machine maintenance, due to water contamination of bearings and electrical devices, is yet another benefit.

Saw mills typically use aluminum or steel saw guide arms with guide pads made of babbitt, a soft metal material. The babbitt material is typically melted and molded onto the guide arms. The guide is then finished by precision grinding both sides of the guide to make the surfaces parallel and to achieve an exact thickness. These guides typically do not last more than 3 to 4 days before needing resurfacing. Mills spend many labor hours refurbishing these babbitt guides on-site. There are environmental and health concerns associated with the lead that may be present in the babbitt material. Replacing babbitt guide pads with a bolt-on hydrodynamic pad that lasts several months before needing replacement or reconditioning would greatly benefit saw mills.

Modification and variation can be made to be disclosed embodiments without departing from the subject of the invention as described herein. For example, the bearing surface perimeter region may not be continuous, may not completely encircled the coolant chamber(s) and in some situations may not be needed. Also, the invention can be used with band saw blades as a band saw guide. Any and all patents, patent applications and printed publications referred to above are incorporated by reference.

1. A saw guide pad, for use with a saw blade movable in a first direction, comprising:
a body having a bearing side, said bearing side having a saw blade bearing surface configured to bear against a side of a saw blade;
said bearing side having a coolant discharge region fluidly coupleable to a source of coolant;
said bearing side having a leading portion and a trailing portion relative to the direction of rotation of the saw blade;
said bearing side having a coolant return chamber formed therein, said coolant return chamber positioned towards the trailing portion of the bearing side, said coolant return chamber fluidly coupled to the coolant discharge region and fluidly coupleable to a coolant exit so that coolant introduced at the coolant discharge region can cool the opposed saw blade and then be removed through the coolant return chamber; and
a seal mounted to the bearing side of the body so that a portion of the seal extends outwardly of the bearing surface.

2. The saw guide pad according to claim 1 further comprising a coolant chamber formed into said bearing side, said coolant discharge region and said coolant return chamber opening into said coolant chamber.

3. The saw guide pad according to claim 1 wherein the bearing surface comprises a perimeter bearing surface region at least partially surrounding said coolant chamber.

4. The saw guide pad according to claim 1 wherein the bearing surface comprises a perimeter bearing surface region completely surrounding said coolant chamber.

5. The saw guide pad according to claim 3 wherein the bearing surface comprises supplemental bearing surface regions.

6. The saw guide pad according to claim 5 wherein the supplemental bearing surface regions comprise bearing surface island regions completely surrounded by said coolant chamber.

7. The saw guide pad according to claim 5 wherein the supplemental bearing surface regions comprise bearing surface connector regions dividing said coolant chamber into a plurality of coolant chambers.

8. The saw guide pad according to claim 7 wherein the coolant chambers have different depths.

9. The saw guide pad according to claim 5 wherein the perimeter and supplemental bearing surface regions are coplanar.

10. The saw guide pad according to claim 5 wherein the bearing side further comprises ramped regions coupling the coolant chamber to at least one of the supplemental bearing surface regions.

11. The saw guide pad according to claim 6 wherein the bearing side further comprises ramp regions coupling the coolant chamber to at least one of the bearing surface island regions.

12. The saw guide pad according to claim 1 wherein the body has a lateral dimension extending from an inner radial side to an outer radial side.

13. The saw guide pad according to claim 12 wherein the coolant discharge region comprises a plurality of coolant discharge openings.

14. The saw guide pad according to claim 13 wherein said coolant discharge openings are sized according to the lateral position of said openings so that coolant delivered through said openings varies according to the lateral position of said openings.

15. The saw guide pad according to claim 13 wherein the coolant discharge openings are user-adjustable-sized coolant discharge openings.

16. The saw guide pad according to claim 12 further comprising means for delivering coolant to the coolant discharge region at rates varying according to the lateral position along the body.

17. The saw guide pad according to claim 1 wherein the coolant discharge region is positioned at the leading portion of the bearing side.

18. The saw guide pad according to claim 1 wherein the seal and the coolant return chamber have similar shapes.

19. The saw guide pad according to claim 1 wherein the body has a leading edge and a trailing edge and the seal is between the coolant return chamber and the trailing edge.

20. The saw guide pad according to claim 19 wherein the seal lies adjacent to the coolant return chamber.

21. The saw guide pad according to claim 1 wherein the bearing side has a recess formed therein containing a portion of the seal.

22. The saw guide pad according to claim 1 further comprising means for biasing the seal outwardly towards an opposed saw blade.

23. The saw guide pad according to claim 22 wherein the biasing means and the seal are separate components.

24. The saw guide pad according to claim 1 further comprising means for biasing the seal outwardly towards the opposed saw blade with an adjustable bearing force.

25. The saw guide pad according to claim 1 further comprising means for biasing the seal outwardly towards the opposed saw blade with a user-adjustable bearing force.

26. The saw guide pad according to claim 1 wherein the seal is made of a polymer material.

27. The saw guide pad according to claim 1 wherein the seal is made of one or more of metal, ceramic, plastic, natural rubber, synthetic rubber, or a composite material.

28. The saw guide pad according to claim 1 wherein the seal comprises a plurality of seal elements.

29. The saw guide pad according to claim 28 wherein the seal is configured to direct coolant to the coolant return chamber.

30. The saw guide pad according to claim 1 wherein the seal comprises means for directing coolant to the coolant return chamber.

31. The saw guide pad according to claim 1 wherein the seal comprises a straight seal.

32. The saw guide pad according to claim 1 wherein the seal is disposed within the coolant return chamber.

33. The saw guide pad according to claim 1 wherein the coolant return chamber comprises a vacuum chamber that is fluidly coupleable to a vacuum source.

34. A saw guide, for use with a saw blade movable in a first direction, comprising a saw guide arm portion and a saw guide pad portion, said saw guide pad portion comprising:
a body having a bearing side, said bearing side having a saw blade bearing surface configured to bear against a side of a saw blade;
said bearing side having a coolant discharge region fluidly coupleable to a source of coolant;
said bearing side having a leading portion and a trailing portion relative to the direction of movement of the saw blade;
said bearing side having a coolant return chamber formed therein, said coolant return chamber positioned towards the trailing portion of the bearing side, said coolant return chamber fluidly coupled to the coolant discharge region and fluidly coupleable to a coolant exit so that coolant introduced at the coolant discharge region can cool the opposed saw blade and then be removed through the coolant return chamber; and
a seal mounted to the bearing side of the body so that a portion of the seal extends outwardly of the bearing surface.

35. The saw guide according to claim 34 wherein the saw guide pad portion is mountable to and dismountable from the saw guide arm portion.

36. The saw guide according to claim 34 wherein said seal is mounted on the saw guide arm portion and extends through the saw guide pad portion.

37. The saw guide according to claim 34 wherein said coolant return chamber comprises a vacuum chamber that is fluidly coupleable to a vacuum source.

38. The saw guide according to claim 34 further comprising a second saw guide pad portion having a second bearing side with a second coolant discharge region.

39. The saw guide according to claim 38 wherein the saw guide arm portion comprises pressure-equalizing fluid conduits fluidly coupling the coolant discharge region on the bearing side to the second coolant discharge region on the second bearing side.

40. The saw guide according to claim 38 further comprising means for equalizing the pressure within the coolant discharge regions on said bearing side and said second bearing side.

41. A saw guide pad, for use with a saw blade movable in a first direction, comprising:
a body having a bearing side;
said bearing side having a leading edge and a trailing edge relative to the direction of movement of the saw blade;
said bearing side having a coolant chamber formed therein towards the leading edge, said coolant chamber coupleable to a source of coolant;
said bearing side having a coolant return chamber formed therein towards the trailing edge, said coolant return chamber fluidly coupled to the coolant chamber and coupleable to a coolant exit so that coolant in the coolant chamber can be removed through the coolant return chamber;
said bearing side having a bearing surface at least partially defining the coolant chamber; and
a seal, mounted to the bearing side of the body so that a portion of the seal extends outwardly of the bearing surface.

42. The saw guide pad according to claim 41 wherein said coolant return chamber comprises a vacuum chamber that is fluidly coupleable to a vacuum source.

43. A saw guide pad, for use with a saw blade movable in a first direction, comprising:
a body having a bearing side;
said bearing side having a leading edge and a trailing edge relative to the direction of movement of the saw blade;
said bearing side having a coolant chamber formed therein towards the leading edge, said coolant chamber coupleable to a source of coolant;
said bearing side having a coolant return chamber formed therein towards the trailing edge, said coolant return chamber opening onto to the coolant chamber and coupleable to a coolant exit so that coolant in the coolant chamber can be removed through the coolant return chamber;
said bearing side having a bearing surface at least partially defining the coolant chamber;
a floating seal, mounted to the bearing side of the body so that a portion of the seal extends outwardly of the bearing surface; and
means for biasing the floating seal outwardly towards the opposed saw blade.

44. The saw guide pad according to claim 43 wherein said coolant return chamber comprises a vacuum chamber that is fluidly coupleable to a vacuum source.

45. A saw guide pad, for use with a saw blade movable in a first direction, comprising:
a body having a bearing side;
said bearing side having a leading edge and a trailing edge relative to the direction of movement of the saw blade;
said bearing side having a coolant chamber formed therein towards the leading edge, said coolant chamber coupleable to a source of coolant;
said bearing side having a vacuum chamber formed therein towards the trailing edge, said vacuum chamber opening onto to the coolant chamber and coupleable to a vacuum source so that coolant in the coolant chamber can be removed through the vacuum chamber;
said bearing side having a bearing surface comprising:
a perimeter bearing surface region circumscribing the coolant chamber; and
supplemental bearing surface regions within the perimeter bearing surface region;
a floating seal, mounted to the bearing side of the body so that a portion of the seal extends outwardly of the bearing surface; and
adjustable force means for adjustably biasing the floating seal outwardly towards the opposed saw blade with an adjustable biasing force.

46. A saw guide, for use with a saw blade movable in a first direction, comprising a saw guide arm portion and a saw guide pad portion, said saw guide pad portion comprising:
a body having a bearing side;
said bearing side having a leading edge and a trailing edge relative to the direction of movement of the saw blade;
said bearing side having a coolant chamber formed therein towards the leading edge, said coolant chamber coupleable to a source of coolant;
said bearing side having a vacuum chamber formed therein towards the trailing edge, said vacuum chamber opening onto to the coolant chamber and coupleable to a vacuum source so that coolant in the coolant chamber can be removed through the vacuum chamber;
said bearing side having a bearing surface comprising:
a perimeter bearing surface region circumscribing the coolant chamber; and
supplemental bearing surface regions within the perimeter bearing surface region;
a floating seal, mounted to the bearing side of the body so that a portion of the seal extends outwardly of the bearing surface; and
adjustable force means for adjustably biasing the floating seal outwardly towards the opposed saw blade with an adjustable biasing force.

47. A floating saw guide seal comprising:
an elongated body having a sealing portion; and
said sealing portion configured to sealingly engage a surface of a saw blade with which it is to be used.

48. The floating saw guide seal according to claim 47 wherein the elongated body is straight.

49. The floating saw guidance seal according to claim 47 wherein said elongated body is made of a polymer. rotary direction, each said saw guide comprising a saw guide arm portion and a saw guide pad portion, at least some of said saw guide pad portions comprising:
a body having a bearing side, configured to bear against a side of a saw blade, comprising:
a leading edge and a trailing edge relative to the direction of rotation of the saw blade;
a coolant chamber formed therein towards the leading edge, said coolant chamber coupleable to a source of coolant; and
a coolant return chamber formed therein towards the trailing edge, said coolant return chamber opening onto to the coolant chamber and coupleable to a coolant exit so that coolant in the coolant chamber can cool the opposed saw blade and then be removed through the coolant return chamber;
a seal mounted to the bearing side of the body so that a portion of the seal extends outwardly of the bearing surface; and
pressure-equalizing fluid conduits fluidly coupling at least some of the coolant chambers to one another.

51. The gang of saw guides according to claim 50 wherein said coolant return chamber comprises a vacuum chamber that is fluidly coupleable to a vacuum source.

52. The gang of saw guides according to claim 50 wherein said pressure-equalizing fluid conduits comprise:
first fluid conduits defined by said saw guide pad portions and fluidly coupled to the coolant chambers; and
second fluid conduits defined by said saw guide arm portions and fluidly coupling the first fluid conduits to one another.

53. The gang of saw guides according to claim 50 wherein said body has first and second bearing sides, and said pressure-equalizing fluid conduits fluidly couple the coolant chambers on said first and second sides to one another.
